(19) United States
(12) Patent Application Publication
(10) Pub. No.: US 2010/0089398 A1
(43) Pub. Date: Apr. 15, 2010

(54) METHOD FOR THE CONSTANT AUTOMATIC MONITORING OF THE REGULARITY OF THE BREATHING OF A DIVER DURING SCUBA DIVES

(76) Inventor: Giovanni DISTEFANO, Torino (IT)

Correspondence Address: STITES & HARBISON PLLC, 1199 NORTH FAIRFAX STREET, SUITE 900, ALEXANDRIA, VA, 22314, US

(21) Appl. No.: 12/574,776

(22) Filed: Oct. 7, 2009

(30) Foreign Application Priority Data
Oct. 10, 2008 (IT) GE2008A000081

(51) Int. Cl. A62B 7/04

(52) U.S. Cl. 128/204.26

(57) ABSTRACT

Method for the constant automatic monitoring of the regularity of the breathing of a diver during scuba dives, characterized in that it involves measuring pressure variations in the air supplied by the regulator first stage which reduces the pressure of the compressed air delivered by the compressed-air bottles to the pneumatic stabilizer jacket and/or to the demand valve caused by the amplitude and frequency of the breathing acts of the diver.

### BACKGROUND AND SUMMARY OF THE INVENTION

The present invention relates to a method and apparatus for the continuous automatic monitoring of the regularity of the breathing of a diver during scuba dives.

It is well known that while under water a diver may become indisposed, possibly only slightly and temporarily but also possibly seriously distressed enough to require intervention and immediate help. However, it is not always possible to intervene in time from the outside, and especially it is almost never possible to be informed in time that an anomaly has occurred in the breathing behaviour of a diver.

It is known that as the diver breathes he causes a wave of low pressure to propagate throughout the system downstream from the regulator first stage, the pattern and frequency of which are analogous to those of breathing. Therefore, any distress in the course of a dive will produce a breathing anomaly in this wave, evidenced in particular by a state of breathlessness—that is, breathing that is shallower and faster than normal breathing.

It is therefore an object of the present invention to provide a system capable of monitoring the breathing rate of a diver and, if this system detects an anomaly and/or any distress in the breathing rate, it can send messages to the diver himself, to the surface support unit, and in certain cases launch a procedure for the controlled ascent of the diver, at the same time sending signals to any diving companions or to the support vessel to alert the appropriate assistance systems.

Specifically, in accordance with the present invention it has been found that it is possible to continuously monitor the regularity of the breathing of a diver by measuring the pressure variations of the air supplied by the regulator first stage from the compressed-air bottles to the regulator, which is known as the intermediate pressure.

The present invention also relates to a monitoring device of the type described above, combined with a dive computer, capable of continuously monitoring the breathing of a diver and signalling and if necessary automatically controlling the ascent of the distressed diver, including the various decompression stops and times.

### BRIEF DESCRIPTION OF THE DRAWINGS

Other objects and advantages of the present invention will appear more fully in the course of the following description of a preferred embodiment, illustrated in the appended drawing, in which:

FIG. 1 is a block diagram of the monitoring system of the invention, and

FIG. 2 is a time/pressure diagram showing possible deterioration of the monitored breathing.

### DESCRIPTION OF THE PREFERRED EMBODIMENT OF THE INVENTION

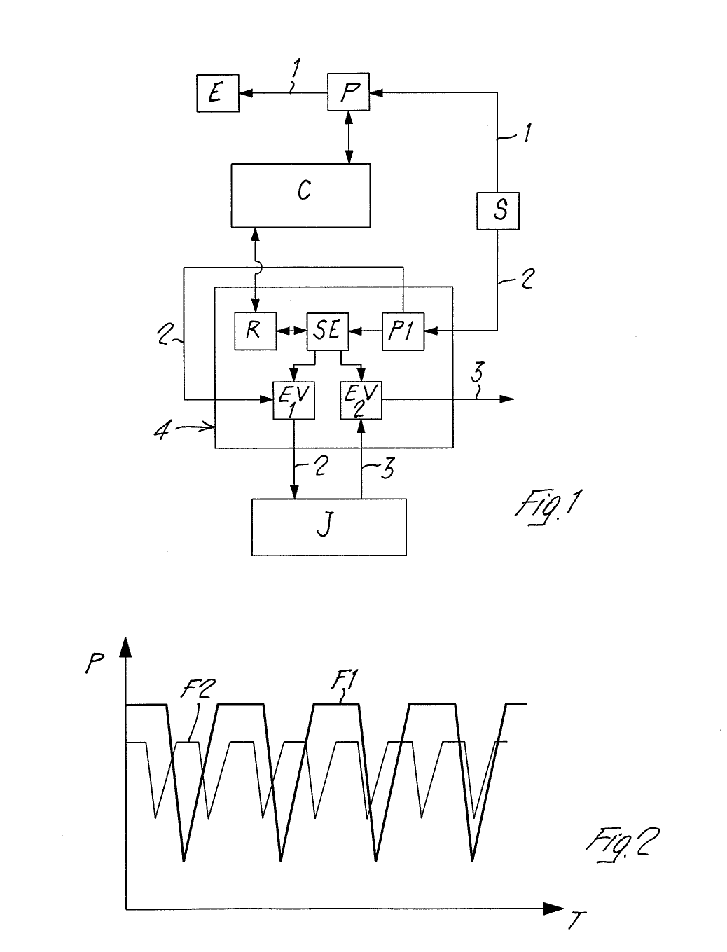

With reference to the drawing, and with particular reference to FIG. 1 of the drawing, S is the first stage in the reduction of the pressure of the air supplied from a bottle (not shown) of compressed air.

From this first stage S the air travels along a first hose 1 which leads to the demand valve E from which the diver breathes breathable air. Advantageously, a sensor P is positioned upstream of the demand valve E on the hose 1 to measure the pressure of the air coming from the first stage S (intermediate pressure), for reasons which will be described later. The sensor P is in two-way communication with the dive computer C.

A second hose 2 also leads away from the first stage S and, via a second pressure sensor P1, leads to an electrically operated valve EV1 and from the latter to the stabilizer jacket J. The pressure sensor P1 communicates the detected intermediate pressure value to an electronic board SE. This board comprises a data processing part which in turn communicates with a two-way remote-control system R in communication with the dive computer C. The electronic board SE also communicates with two electrically operated valves EV1 and EV2, electrically operated valve EV1 being the jacket J filling valve, while electrically operated valve EV2 communicates with the jacket via the hose 3 which determines the exhausting of air from the jacket J. Naturally, the electrically operated valves EV1 and EV2 can also be operated manually by the diver to vary the buoyancy of the jacket J.

The electronic board SE, the pressure sensor P1, the two-way control R, the two electrically operated valves EV1 and EV2, and the dive computer C are all preferably contained within the actuator 4.

The operation of the device described will be obvious.

Every time the diver breathes air in, there is an oscillation in the intermediate air pressure in hoses 1 and 2. In the case of regular breathing, this oscillation will have a well-defined amplitude and frequency, illustrated for example by curve F1 in FIG. 2. If the diver becomes distressed, the amplitude of the oscillation of the intermediate air pressure will be reduced, while its frequency will increase, as illustrated by curve F2 in FIG. 2, and these data will be interpreted by the computer C as the diver becoming distressed. At this point the computer C will use the electrically operated valves EV1 and EV2 to start a procedure of controlled ascent of the diver, in accordance with the ascent table stored in the computer C with regard both to compulsory decompression stops and the time spent at these stops. Simultaneously, the computer C may transmit this information to the diving companions of the distressed diver, and/or to the surface vessel, which may thus depending on the seriousness of the situation alert the assistance means.

Clearly, the valves EV1 and EV2 may also be operated manually, by means of suitable pushbuttons, in order to give the jacket J, and hence the diver, the desired buoyancy in the course of normal dives.

The present invention is not of course limited to the embodiment illustrated and described herein, which is offered purely as a non-restrictive example, but rather encompasses all such modifications and variations as lie within the broader scope of the inventive concept claimed below.

For example, if the diver completely stops breathing for more than a certain time limit, which may be predefined or may be entered by the diver himself, the computer C will start the automatic diver ascent procedure.

I claim:

1. Method for the constant automatic monitoring of the regularity of the breathing of a diver during scuba dives, characterized in that it involves measuring pressure variations in the air supplied by the regulator first stage which reduces the pressure of the compressed air delivered by the compressed-air bottles to the pneumatic stabilizer jacket and/or to the demand valve (intermediate pressure) caused by the amplitude and frequency of the breathing acts of the diver.

2. Device for implementing the method according to claim 1, comprising a pneumatic stabilizer jacket; a regulator first stage which reduces the pressure of the air supplied by a compressed-air bottle; and a first hose leading to a demand valve from which the diver breathes the air; the device being characterized in that downstream of the attachment for the hose is a sensor for measuring the intermediate air pressure, the signal output by the sensor being sent to an electronic board comprising a data processing part and a part for the remote transmission of these data to a dive computer.

3. Device according to claim 2, characterized in that said first stage also leads to a second hose communicating with the jacket and monitored by a pressure sensor which communicates the value of the intermediate pressure detected by the electronic board which also communicates with a first electrically operated valve and a second electrically operated valve, in which the said first electrically operated valve is the jacket filling valve, while the said second electrically operated valve controls the exhausting of air from said jacket.

4. Device according to claim 2, in which when the said computer detects an abnormal condition in the breathing of the diver or when it detects a complete absence of breathing for longer than a certain predetermined time, it can initiate, via the said electrically operated first and second valve, a controlled diver ascent procedure, and/or can transmit this information to the dive companions of the diver in trouble and/or to surface support systems.
